(19) United States
(12) Patent Application Publication
(10) Pub. No.: US 2003/0086116 A1
(43) Pub. Date: May 8, 2003

(54) Method to automatically evaluate a hard copy response and immediately generate commentary based thereon

(76) Inventors: John M. Hall, Boise, ID (US); Craig McCoy, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/012,993

(22) Filed: Nov. 5, 2001

(51) Int. Cl. B41J 1/00; G06F 15/00

(52) U.S. Cl. 358/1.15

(57) ABSTRACT

The present invention provides a method for automatically generating commentary regarding a hard copy image. The method includes the steps of providing an image in hard copy format, scanning the image with a multi-functional device to produce an electronic copy of the image and sending the electronic copy of the image to a processor. The processor then initiates a computer program to produce commentary regarding the electronic copy image. The processor then sends the commentary to the multi-functional device, which prints the commentary.

### FIELD OF THE INVENTION

The present invention is related to the field of machine-grading of tests. More specifically the present invention provides systems and methods for automatically evaluating hard copy responses such as exam answer sheets and immediately generating commentary based thereon.

### BACKGROUND OF THE INVENTION

Standardized tests are used in a variety of situations throughout society. From schools, to workplace, to government agencies, standardized tests are used to determine an examinee's ability to answer various questions correctly in any number of situations and on any number of subjects. Generally, standardized tests are presented in a multiple-choice format. Typically, examinees are presented with a set of possible answers and asked to select the answer they believe to be correct. Standardized tests are used to place children in classes, to give students grades, to place students in college and graduate programs, to select scholarship recipients, to determine a job applicant's aptitude for various jobs, and to determine whether a driver's license applicant has learned the rules of the road, just to name a few examples. Moreover, similar types of systems are often used for voting and opinion polls.

Past methods of grading standardized tests include manual and machine grading. Manual grading is expensive and time-consuming and relies on the grader's ability and desire to correctly ascertain the examinees' responses. Machine grading is generally less time-consuming than manual grading, but typically requires the test administrator to obtain extra equipment. Alternative grading systems, particularly those that provide a detailed analysis of the examinees' results, require the examinee to take the exam on a computer. However, because the examinee must use a computer monitor and keyboard to view questions and input answers, some examinees may find taking tests on a computer to be significantly more difficult than using a standard paper question booklet and answer sheet. For example, while a standard paper question booklet and answer sheet enable an examinee to quickly flip through and answer questions in any desired order, it is more difficult to view multiple questions at one time on a computer test. Moreover, some examinees find reading questions on a monitor difficult and tiring.

### SUMMARY OF THE INVENTION

The present invention provides a method for automatically generating commentary regarding a hard copy image. The method includes the steps of providing an image in hard copy format, scanning the image with a multi-functional device to produce an electronic copy of the image and sending the electronic copy of the image to a processor. The processor then initiates a computer program to produce commentary regarding the electronic copy image. The processor then sends the commentary to the multi-functional device, which prints the commentary.

### BRIEF DESCRIPTION OF THE FIGURES

FIG. 1 is a schematic illustration of one embodiment of the system of the present invention.

FIG. 2 is a flowchart depicting exemplary steps that could be used in one embodiment of the present invention.

FIG. 3 is an example of one type of answer sheet that could be used with the present invention.

FIG. 4 is an example of another type of answer sheet that could be used with the present invention.

FIG. 5 is an example of a third type of answer sheet in the form of a ballot that could be used with the present invention.

FIG. 6 is an example of a fourth type of answer sheet in the form of a survey questionnaire that could be used with the present invention.

FIG. 7 is a flowchart depicting the exemplary steps that could be taken by a processor running a grading computer program according to the present invention.

FIG. 8 is an example of a report that could be generated after evaluation of the answer sheet shown in FIG. 3.

FIG. 9 is an example of a report that could be generated after evaluation of the answer sheet shown in FIG. 4.

FIG. 10 is an example of a report that could be generated after evaluation of the answer sheet shown in FIG. 5.

FIG. 11 is an example of a report that could be generated after evaluation of the answer sheet shown in FIG. 6.

### DETAILED DESCRIPTION OF THE INVENTION

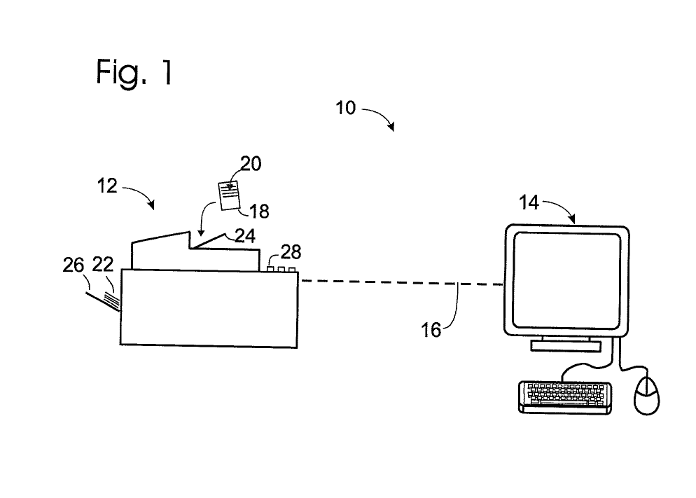

According to one embodiment, the present invention provides a system in which a multi-functional device scans a hard copy image to create an electronic image of the original hard copy image. The electronic image is sent to a processor adapted to initiate a processing routine, or computer program, that automatically generates commentary on the electronic image. The commentary is then sent back to the multi-functional device for printing. In some cases, the commentary is printed directly onto the original hard copy image. A typical system according to this embodiment of the present invention is shown in FIG. 1.

As shown, system 10 includes a multi-functional device 12, which is in electronic communication with processor 14 via wired or wireless communication link 16. Processor 14 may be integrated within device 12 or may be separate from the device, as shown. In the embodiment depicted in FIG. 1, processor 14 takes the form of a desktop computer. However, processor 14 may take the form of any suitable computing system capable of processing data and generating data therefrom. By communicate, it is meant that device 12 and processor 14 are able to send and receive electronic messages to and from each other.

As used herein, the terms “multi-functional device” or “device” shall refer to any apparatus adapted to produce an electronic copy of an original hard copy image (i.e. scan), produce one or more hard copy duplicate images of the original hard copy image (i.e. copy), send electronic messages (i.e. transmit), and receive electronic messages (i.e. receive). Devices that are capable of scanning, copying, transmitting, and receiving images are known and commercially available. These machines are commonly referred to as “multifunctional”, “all-in-one”, or “printer-copier-fax” machines. Such devices are currently available for both home-office and commercial-scale applications.

Returning to FIG. 1, multi-functional device 12 receives media 18 including a hard copy image 20 and produces a hard copy duplicate image 22 and a soft copy duplicate image (not shown) therefrom. The multi-functional device 12 typically includes a media input tray 24 and a media output tray 26. In addition, device 12 may include a series of user input devices 28, which allow the user to switch between the various functions of the device, and request that the device perform specific tasks. These input devices may further define the manner in which the tasks are to be performed, for example by indicating the number of copies to be made, the brightness level of the image to be duplicated, the size of the image to be duplicated, etc.

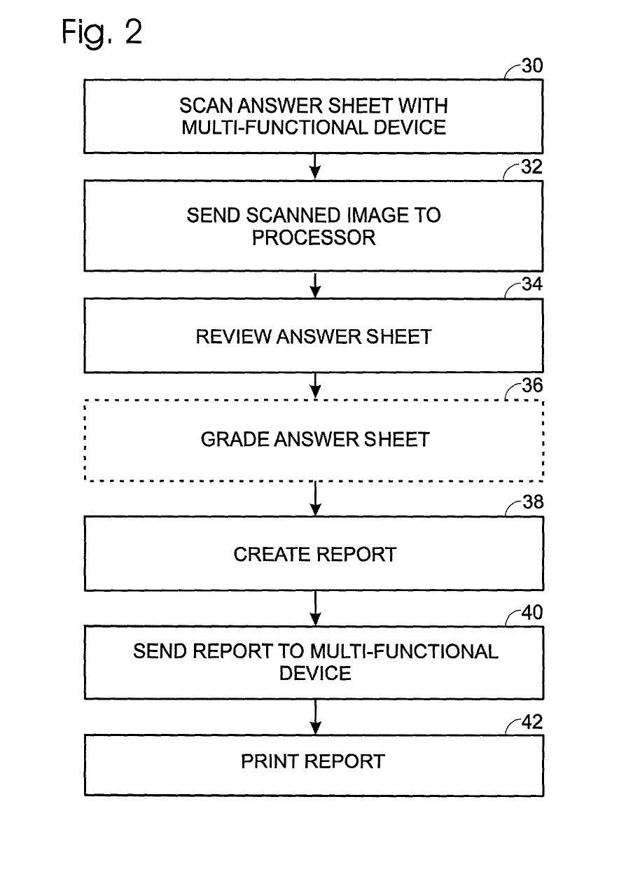

Turning to FIG. 2, in one embodiment, the original hard copy image is a completed test answer sheet and the present invention provides a system to automatically evaluate an exam and generate a written report based on the examinee's answers. In this embodiment, the system of the present invention typically functions as follows. An examinee completes a test by identifying answers on an answer sheet. For example, if the test is presented in a standard multiple-choice format, the user will typically indicate his or her chosen answer by marking an answer sheet in an appropriate area.

For ease of discussion, the terms “examinee,” “test-taker,” or “respondent” shall refer interchangeably to the person taking the test, as described above, even when the test is a poll, survey, or vote and the examinee does not receive a grade or score.

Furthermore, the terms “examiner” or “test administrator” shall be used interchangeably to refer to the person or entity administering the exam. The test administrator may be a teacher, an organization, an employer, a government agency, or the like. The test administrator may or may not be the person to whom, or entity to which, the results of the test are provided. For example, an independent organization may administer a given college entrance exam, the results of which are sent to colleges, universities, and/or organizations selected by the examinee.

Continuing down the flowchart of FIG. 2, once the test is completed by the examinee, the answer sheet is scanned by a multi-functional device at 30, creating an electronic copy of the answer sheet. The scanned image is sent to a processor at 32, which runs software capable of reviewing the answer sheet at 34. If the test is to be graded, the software may then grade the answer sheet at 36, (shown in dashed lines to indicate an optional step).

As will be appreciated, the presently described system may be used to administer and grade tests, but may be used for other application including the administration and evaluation of polls, surveys, elections and the like. As used herein, the terms “standardized test,” “test,” or “exam” encompass any examinee response that may be evaluated automatically by a machine. Typically these are multiple-choice tests but may include additional formats, such as those listed above. Accordingly, the terms “standardized test,” “test,” or “exam” are not limited to those applications in which the examinee's answers are being evaluated in comparison to a correct or incorrect answer. For example, for the purposes of the present invention, the terms “test” or “standardized test” encompass polls, surveys, elections, and the like.

As used herein “machine grading” includes any method for automatically evaluating the responses recorded on an answer sheet that does not require human input. Typically, machine grading is used to evaluate those portions of an exam that are objective. However, machine grading may be used in certain cases to evaluate subjective portions of exams. The methods and apparatus provided by the present invention are suitable for any exam in which machine grading is used.

Machine graded exams generally require the examinee to indicate the selected answer on an answer sheet. Typically, the examinee darkens a circle, square or other space that corresponds to the answer the examinee intends to select with a writing implement, such as a pencil. However, alternative methods of indicating a selected answer may be used. For example, some methods and apparatus used for machine grading are capable of reading typewritten or hand-written answers. Regardless of the method used to indicate the selected answer, after the examinee has completed the exam by marking answers on the answer sheet, a grading machine capable of determining whether the answers selected by the examinee are correct or incorrect reads and scores the answer sheet.

As stated above, suitable devices are commercially available and commonly sold under the description “multi-functional copiers”. Many commercially available multi-functional copiers have features that make them particularly well suited for the system of the present invention. For example, they may include an automatic feeder, which allows a user to place a stack of sheets in the copier input tray. The multi-functional copier is then able to scan each paper individually and return them to an ordered pile after scanning. Many commercial multi-functional copiers include other features such as collating, stapling, etc. that may be useful for the present invention. Furthermore, many commercial multi-functional copiers have the ability to scan and print on double-sided paper, allowing the test administrator to use double sided answer sheets or print reports on the back of answer sheets.

Moreover, many multi-functional copiers include a relatively large scanning bed wherein the item to be scanned is laid out on the bed, rather than using the rolling scanners that are often used in traditional machine graders. The use of a scanning bed allows the test administrator to scan the answer sheet and additional articles in the same scan. The additional articles may include, for example, an identification card or separate sheet containing identification or demographic information about the examinee.

Likewise, additional functions of the multi-functional copier may be utilized. For example, many multi-functional copiers include a fax machine. In this case, in addition to printing out a hard copy version of the report and test to give to interested parties, the machine could automatically fax the reports to remote locations.

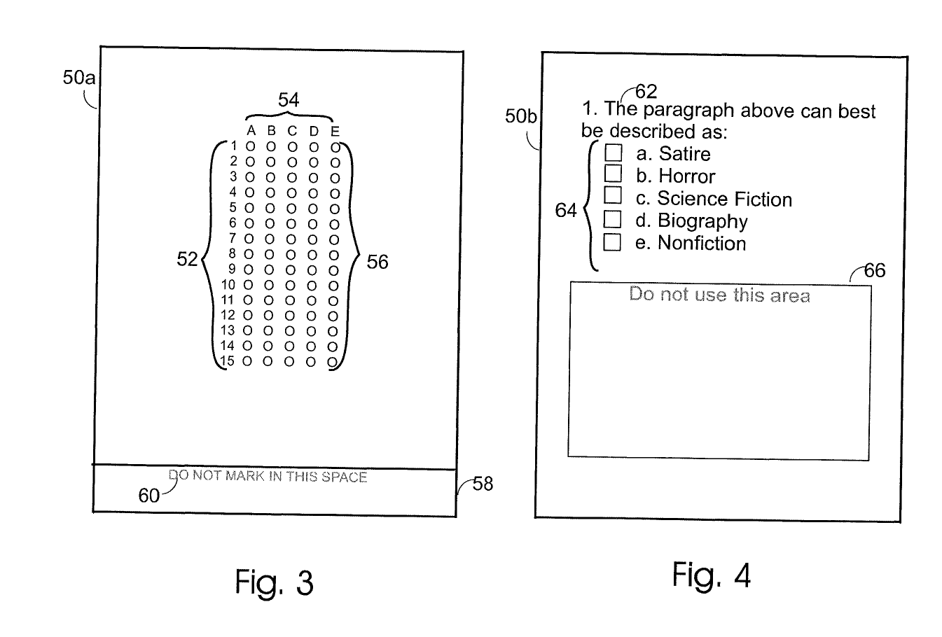

FIGS. 3-6 depict examples of answer sheets 50 that could be used with the present invention. As described below, the test administrator may use standard or generic answer sheets (an example of which is shown in FIG. 3) or may use personalized or test-specific answer sheets of the type shown in FIGS. 4-6.

FIG. 3 depicts an exemplary multiple-choice answer sheet 50a that might be suitable for a typical school exam. The answer sheet contains a series of question numbers 52 in a vertical column with a series of possible answers 54 labeled “A”, “B”, “C”, “D”, and “E” in horizontal rows next to the question numbers. The answer sheet further includes answer bubbles 56, which can be darkened by the examinee using a pen or pencil to indicate the selected answer. Typically, the examinee is provided with a separate test booklet containing the questions and possible answers that correspond to the answer bubbles on the answer sheet. As will be appreciated this type of “generic” answer sheet allows the test administrator to use the same answer sheet for a wide variety of exams simply by changing the test booklet.

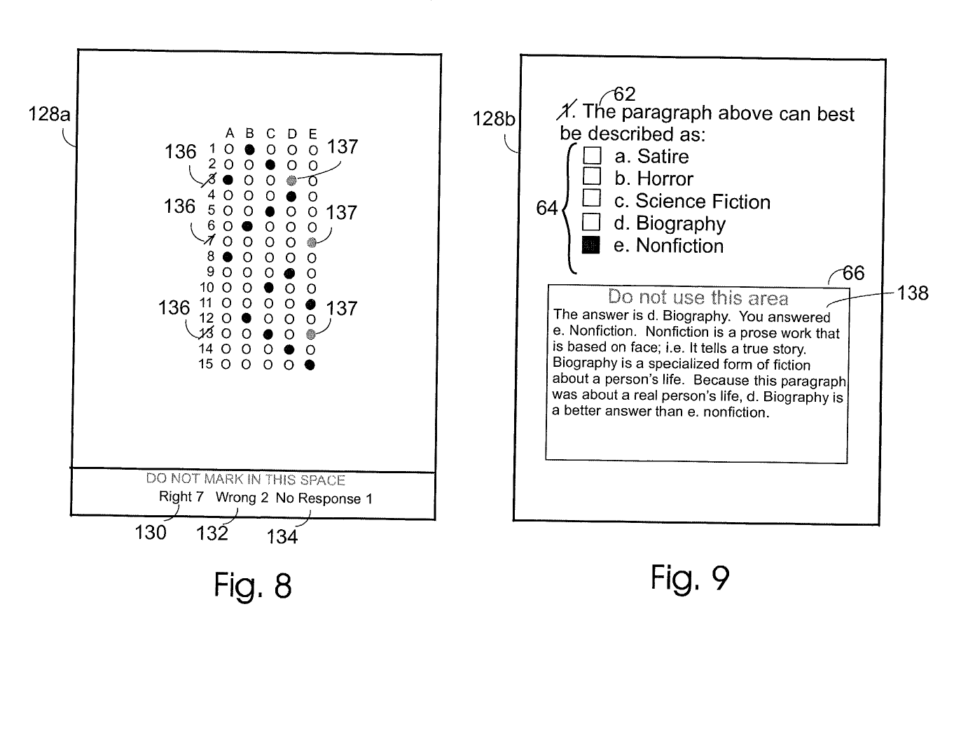

As will be appreciated, the answer sheet shown in FIG. 3 may be modified in any number of ways to provide an answer sheet that is appropriate for the test being given. As non-limiting examples, the number of questions and/or possible answers could be altered, space could be provided to allow the examinee to enter identification or demographic information, and/or the size, shape, and/or placement of the answer bubbles could be changed. As shown, the answer sheet may include blank areas 58. These blank areas may be reserved to provide space to mark the examinee's score or make remarks about the examinee's test, as described with respect to FIG. 8, below. In this case, the blank areas may be labeled with some type of admonition 60, requesting that the test taker not write in, or otherwise use, the space.

FIG. 4 depicts another exemplary answer sheet 50b suitable for the system of the present invention. In this example, a test question 62 is printed on the answer sheet followed by a series of potential answers, each including an answer square 64, which can be darkened by the examinee using a pen or pencil to indicate the selected answer. Also included on this answer sheet is a space 66, provided after each test question, to allow for commentary regarding the examinee's answer, as described with respect to FIG. 9, below.

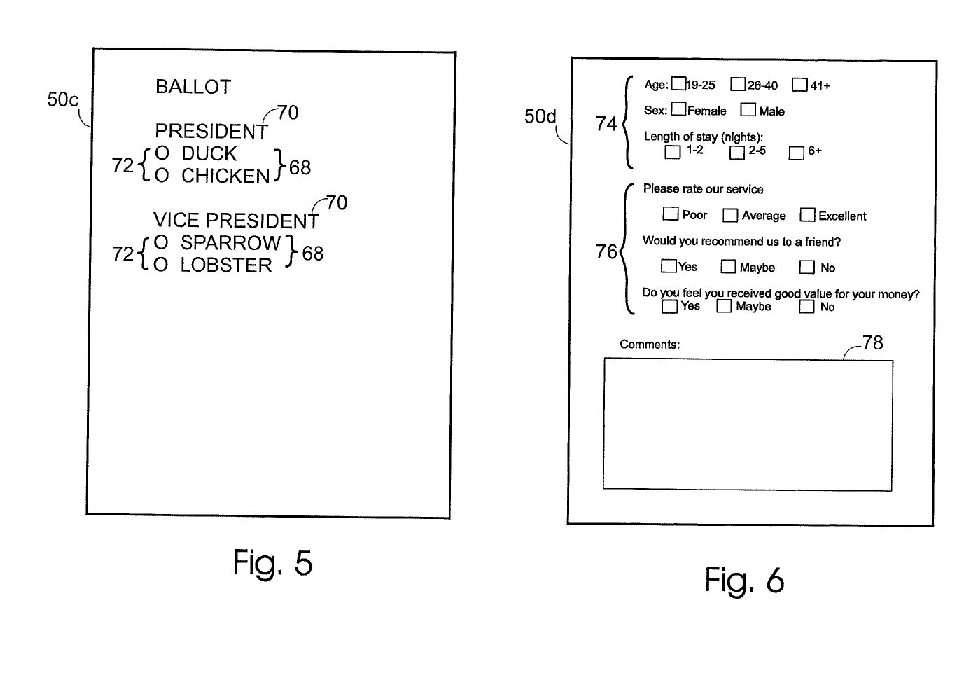

FIG. 5 depicts an exemplary answer sheet 50c that might be suitable for use as an election ballot. In this case, the names of the candidates 68 and the positions for which they are running 70 are listed on the answer sheet. The voter may then mark the space 72 next to the candidate for whom the voter wishes to vote. As with the other exemplary answer sheets, alternative configurations may be used. For example, the respondant may be provided with a separate booklet listing each candidate and the corresponding area to mark on the answer sheet in order to cast a vote for each candidate. This configuration allows for the use of a generic answer sheet that could be appropriate for a wide variety of surveys or tests, such as the answer sheet depicted in FIG. 3.

FIG. 6 depicts an alternative exemplary answer sheet 50d that takes the form of a survey questionnaire. This answer sheet includes a series of demographic questions 74 that can be used to obtain information about the examinees. The demographic questions are followed with a series of survey questions 76. As will be appreciated, these survey questions may query the test taker about any desired subject and should in no way be limited to the questions or configuration shown in FIG. 6. Furthermore, the survey questionnaire may include an area 78 to allow for handwritten comments. As with the answer sheets described above, the questions could be provided separately, allowing the surveyors to use a generic answer sheet, such as that depicted in FIG. 3.

As will be appreciated, the above-described answer sheets include a variety of configurations and formats. These configurations and formats may be used in any combination or sub-combination with or without additional modification, as desired by the test administrator.

As stated above in reference to FIG. 2, once the answer sheet 50 is scanned and an electronic image is created, the electronic image is sent to the processor 14, where a specialized computer program evaluates the answer sheet. For the purposes of the present invention, a “computer program” may be program, routine, or symbolic language that controls the functioning of the processor and directs the operation of the presently described system.

Typically, the evaluation will take place by comparing the examinee's answers with a set of correct answers, generally referred to as the answer key. The answer key may be included in the computer program or may be loaded by the test giver. For example, the computer program may include the option for the test administrator to initially scan the answer key prior to scanning the examinee's answer sheets. In this case, the test administrator may mark an answer sheet with the correct answers and scan this answer sheet first, indicating to the software that the answers provided on this answer sheet are to be considered the answer key. Inclusion of a special mark on the answer sheet, selection of a particular input button on the multifunctional device, or any other suitable method may identify the answer key to the computer program. The computer program is then able to identy the correct answers based on the answer identified on the answer key. This system enables the test administrator to easily switch from one test to another simply by submitting a new answer key to the computer program. Alternatively, the administrator may manually enter the correct answers directly into the processor using a desktop or other computer interface.

The computer program should be able detect the examinee's answers. When the answer sheet provides specific areas for the examinees to mark their answer choices, i.e. answer bubbles or squares, the computer program may detect the selected answer by detecting the comparative levels of brightness between the various answer areas. Those answers corresponding to the answer areas having the least bright (or darkest) regions are then registered as the answers selected by the examinees. The computer program then compares the detected answer with the answer provided by the answer key. When the answers match, the computer program may indicate that a correct answer has been selected by the examinee. When the answers do not match, the computer program may indicate that an incorrect answer has been selected by the examinee.

In some embodiments, the computer program may store in memory which questions were answered correctly and which questions were answered incorrectly by a given examinee. This information may be stored only for the length of time necessary to grade a given exam, and create an individual test report on that exam or the information may be stored for the length of time required to grade all of the individual tests from the same exam. This stored information can then be used to create a report summarizing the scores and answers from all of the test takers. Furthermore, the information could be stored indefinitely to allow for the creation of reports over a given period of time. In this manner, the computer program can maintain a record of which questions were answered correctly and which questions were answered incorrectly by examinees over any designated time period. Typically, this information is stored by the program in a database. The database may be accessible to the test administrator to allow the administrator to manipulate the test data in order to create a wide variety of customized reports.

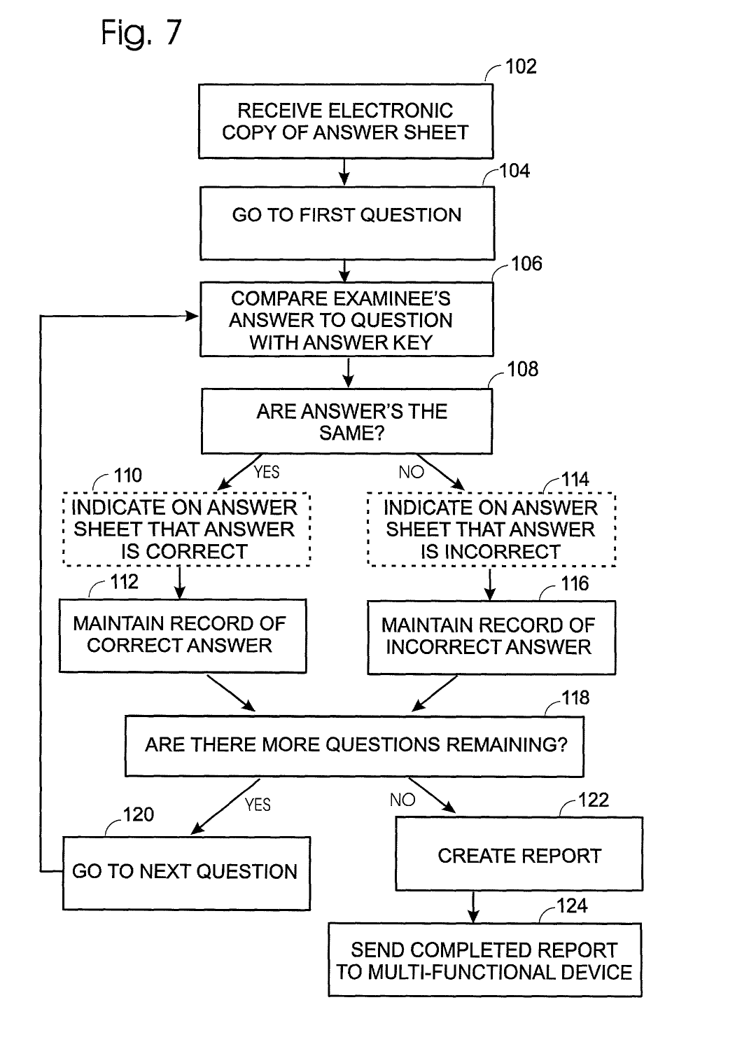

FIG. 7 is a flowchart depicting one method of performing the evaluation or grading process (indicated at 36 in FIG. 2). At 102, a computer program receives an electronic copy of an answer sheet completed by an examinee. At 104, the computer program finds the first question. At 106, the computer program compares the examinee's answer to question 1 with the answer to question 1 from the answer key. At 108, the computer program determines whether the answers are the same or different. If the answers are the same the computer program may indicate on the answer sheet that the question was answered correctly at 110, (drawn with dashed lines to show that the step is optional). Alternatively, the computer program may simply record that a correct answer was given at 112. If the examinee's answer differs from the answer on the answer key, the computer program may indicate on the answer sheet that the question was answered incorrectly at 114, (again drawn with dashed lines). Alternatively, the computer program simply records that an incorrect answer was given at 116. At 118, the computer program determines whether any questions remain. If the answer is yes, the computer program proceeds to the next question at 120 and repeats the cycle. If the answer is no, the computer program generates a report at 122 and sends the completed report back to the multi-functional device at 124.

Returning to FIG. 2, after the reviewing or grading step, the software creates a report at 38 including commentary based on the answers identified on the answer sheet by the examinee. The report is then sent to the multi-functional device at 40, where the report is printed at 42. In some cases, the report may be printed on the original answer sheet, a copy of the answer sheet, or may include scanned images from the original answer sheet.

The individual test report includes an evaluation of the examinee's performance on the test. The report may include a variety of types of evaluations. The simplest type of report generally indicates the number of questions that the examinee answered correctly (and/or incorrectly). FIGS. 8 and 9 depict examples of individual test reports 128a, 128b.

FIG. 8 is an example of the simplest style of individual test report 128a. The report shown in FIG. 8 corresponds to a completed answer sheet of the type shown in FIG. 3. In this particular example, the report was printed directly onto the original answer sheet, or a copy thereof. The report lists the number of questions answered correctly at 130, the number of questions answered incorrectly at 132, and the number of questions for which there was no response at 134. As will be appreciated, the report could also include percentages of correct, incorrect, or unanswered questions or any additional information, as desired. This additional information may include an indication of which questions were answered correctly (and/or incorrectly), shown in FIG. 8 by slash marks 136 through the numbers of the questions that were either answered incorrectly or not answered at all. Moreover, the report may indicate the correct answer for those questions for which an incorrect or no answer was selected by the examinee, as shown at 137. Furthermore, the report may include a detailed analysis of the answers such as a cluster analysis of the types of questions that were answered correctly (and/or incorrectly) (not shown).

FIG. 9 is an example of a different type of report 128b that could be generated from the style of answer sheet shown in FIG. 4. As with the report shown in FIG. 8, in this example, the report is printed directly on the original answer sheet, or a copy thereof. However, as described above, the answer sheet provides space 66 for comments 138 about the examinee's answer. In this example, space has been used to provide the examinee with an explanation of the correct answer and why the examinee's proposed answer was incorrect.

These explanations may be maintained as part of the computer program's database. For example, the computer program may include a database listing an explanation for each possible answer. When the software detects that an examinee has answered a question incorrectly, the computer program may pull the explanation that matches the answer given by the examinee and the explanation that matches the correct answer and include these explanations in the report. In this way, examinees are provided with reports that help them learn from their mistakes and try to improve their score the next time they take the test.

As previously described in reference to FIG. 2, after the computer program creates the report, the report may be sent to a printer to produce a hard copy version. In one embodiment, the report is sent to the same multi-functional device 12 on which the original answer sheet was scanned. In this case, the report may be printed directly onto the original answer sheet, as shown and previously described with respect to FIGS. 8 and 9. In addition, several copies may be generated at one time to provide copies for the test administrator, examinee, and any other interested party, such as a parent, scholarship committee, media, etc.

Alternatively or additionally, the computer program may make a summary report evaluating all of the responses from all of the examinees. This report may be used so that a single examinee can assess his or her performance on the test in comparison to all of the other test takers. In addition, the test administrator may use the report to determine how the examinees performed as a whole on the test. Typically these types of reports would include the average and median score on the test. In addition, information about the test itself can be gleaned from these types of reports, for example, if the report indicates that one of the questions elicited more than the expected number of incorrect responses, a test administrator may determine that the question itself was confusing or improperly worded and the question may be thrown out of the test. Furthermore, if the test includes information regarding demographic information about the examinees, (i.e. gender, age, race or ethnicity, home state, education level, etc.) the computer program may generate reports that break down the various answers and results based upon any combination of demographics.

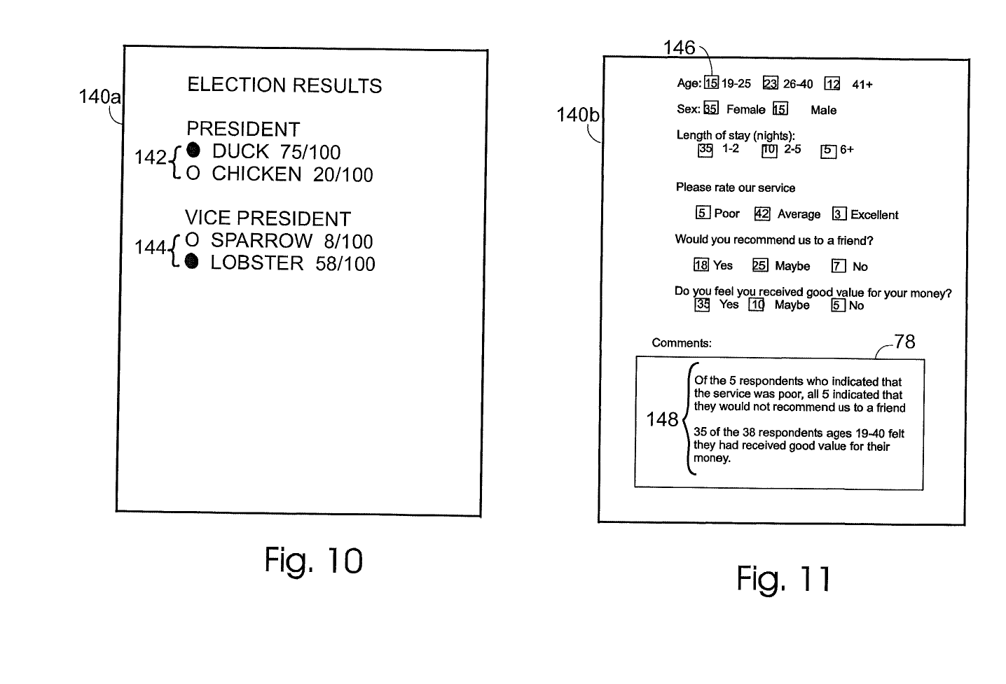

As previously described, the answer sheet may be used to record votes or opinion poles, as shown in FIGS. 5 and 6. In this case, the computer program does not compare the examinee's answers with a grading key, but instead simply makes a record of each of the examinee's answers. In this case it may be particularly desirable to generate a summary report 140 indicating all the responses from all of the examinees. Examples of summary reports are shown in FIGS. 10 and 11.

FIG. 10 shows an example of a summary report 140a that may be generated from the ballots of FIG. 5. Typically, the only information that is desired is the number of votes cast for each candidate, shown on FIG. 10 by a blackening of the circle next to the elected candidate, 142, 144. However, additional information may be included, if desired, such as the total number of votes cast, the percentage of votes cast for each candidate, the number of non-votes for a particular position, etc. Alternatively or additionally, the ballots may be numbered to indicate the voting district from which each individual ballot was received or other demographic information.

FIG. 11 shows an example of a summary report 140b that may be generated from the survey answer sheets of FIG. 6. The summary report shown in FIG. 11 includes the number of questionnaires received indicating each response in the box corresponding to such response, as, for example, shown at 146. In area 78, the summary report may further include a thorough analysis of the responses received, as shown at 148. For example, the summary report may indicate various types of linkages between answers. Linkage analysis may show that when a respondent answered a particular answer on one question they were likely to give a second particular answer on a second question. This may allow an administrator to better gauge the responses received. Alternatively, the summary may indicate that a certain question was ignored more often than other questions, possibly indicating that the question designer may want to change or rewrite the question. In addition, the summary report may include information regarding responses as they break down along various demographic lines. Moreover, any written comments included in area 78 may be scanned and stored by the computer program. The comments may then be pooled and printed together.

As will be appreciated, the above-described reports provide a variety of configurations and formats. As with the design of the answer sheets, these configurations and formats may be used in any combination or sub-combination with or without additional alterations, as desired by the test administrator.

The present invention may be useful in any situation in which standardized tests are given. In one embodiment, the present invention provides a quick and inexpensive method for evaluating standardized tests and generating reports based upon those tests using equipment that can be used for other purposes. Thus, the present invention is particularly well suited for those situations in which standardized tests are given infrequently and there is little incentive to obtain expensive dedicated hardware to evaluate exams.

For example, as described above, the present invention provides for the use of a commercially available multi-functional copier as a multi-functional device. Due to the wide range of uses of such devices, many organizations such as schools or voting districts may already own a multi-functional copier and computer. Therefore, it is contemplated that the system of the present invention may make use of equipment already owned by the user, with the simple addition of a computer program adapted to direct the pre-existing equipment to perform the functions described above. In this manner, schools or voting districts that cannot afford to maintain equipment solely for the use of grading exams or counting ballots may make use of the present invention and pre-existing equipment.

Alternatively, the system of the present invention could be provided as a complete system including a multi-functional device capable of performing all the functions of a multi-functional copier, a processor, and a suitable computer program. In this case, specific modifications may be made to the multi-functional device to make it easier for the test administrator to use. For example, the multi-functional device could include user inputs directed specifically to the grading or reporting features of the system. Thus, a first user input on the device could inform the system that an answer key is being scanned. A second user input button could inform the system that a completed answer sheet corresponding to the answer key is being scanned. Additional user inputs could enable the administrator to design or print the reports in the manner desired.

In addition to the above, the present invention allows the test administrator to maintain an electronic record of each examinee's answer sheet. This may serve to prevent examinees from changing their answers after the test is graded or allow the test administrator to maintain a record of the examinee's past performance. Furthermore, the computer program may be adapted to maintain and evaluate a particular examinee's performance on tests over a period of time. Thus providing a record of an examinee's improvement in various areas.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A method for automatically generating commentary regarding a hard copy image comprising:
scanning the image with a multi-functional device to produce an electronic copy of the image;
sending the electronic copy of the image to a processor
initiating a computer program to automatically produce commentary regarding the electronic copy image;
sending the commentary to the multi-functional device;
printing the commentary with the multi-functional device.

2. The method of claim 1 wherein the hard copy image includes a completed answer sheet including answers selected by an examinee.

3. The method of claim 2 further including the step of initiating a computer program to analyze the answers selected by the examinee.

4. The method of claim 2 wherein the commentary includes a test score.

5. The method of claim 4 wherein the commentary includes an explanation as to why incorrect answers were incorrect.

6. The method of claim 2 wherein the commentary is printed on the answer sheet.

7. The method of claim 2 wherein the commentary includes a summary report based on a plurality of answer sheets.

8. The method of claim 2 wherein the answer sheet is an answer sheet for a multiple-choice test.

9. The method of claim 2 wherein the answer sheet is an election ballot.

10. The method of claim 2 wherein the answer sheet is a survey questionnaire.

11. The method of claim 1 wherein the step of printing includes printing multiple copies of the electronic image and commentary.

12. The method of claim 1 further comprising the step of communicating the commentary to a remote location.

13. The method of claim 1 wherein the computer program is adapted to maintain a record of performance on past exams.

14. A system for grading a standardized test wherein a hardcopy answer sheet including an examinee's responses to questions from the standardized test has been generated by the examinee, the system comprising:
a processor adapted to run a computer program, the computer program being adapted to evaluate the examinee's responses to the questions to determine whether each of the examinee's responses is correct or incorrect and create a report based on the examinee's responses; and
a multi-functional device in electronic communication with the processor and including:
a scanner adapted to produce an electronic copy of the hard copy answer sheet for evaluation by the processor; and
a printer adapted to produce a hard copy image of the report.

15. The system of claim 14 wherein the report is produced on the hard copy answer sheet.

16. The system of claim 15 wherein the report includes commentary based on examinee responses.

17. The system of claim 16 wherein the hard copy answer sheet includes a blank space for printing commentary based on examinee responses.

18. The system of claim 14 wherein the computer program is further adapted to compare examinee responses to responses on an answer key.

19. The system of claim 18 wherein the answer key is provided to the computer program by scanning a hard copy of the answer key prior to grading the hard copy answer sheet.

20. The system of claim 14 wherein the multi-functional device further includes a facsimile device for transmitting data.

21. The system of claim 14 wherein the computer program is further adapted to create a summary report based on a plurality of completed hard copy answer sheets.

22. An article comprising: a storage medium having stored thereon instructions that, when executed, result in a computing platform having the capability to:
receive a scanned image of a completed answer sheet for a standardized test that has been taken by an examinee, the scanned image having been sent from a copier;
evaluate whether each examinee response is correct or incorrect;
create a report based on the examinee responses;
send the report to the copier in a suitable format such that the report can be printed by the copier.

23. The article of claim 22 wherein the computing platform further has the capability to create a summary report based on a plurality of completed hard copy answer sheets.

24. The article of claim 22 wherein the report includes test scores.

25. The article of claim 22 wherein the report includes an explanation of why the response was correct or incorrect.

26. The article of claim 22 wherein the report is printed on the completed answer sheet.

27. The article of claim 22 wherein the computing platform further has the capability to communicate the report to a remote location.

28. The article of claim 22 wherein the computing platform further has the capability to maintain a record of performance on past exams.
